(19) United States
(12) Patent Application Publication
(10) Pub. No.: US 2020/0020014 A1
(43) Pub. Date: Jan. 16, 2020

(54) METHOD AND APPARATUS FOR ASSESSING PRICE FOR SUBSCRIPTION PRODUCTS

(71) Applicant: LG ELECTRONICS INC., Seoul (KR)

(72) Inventors: Moon Sub Jin, Yongin-si (KR); Ki Young Kwak, Incheon (KR); Mi Sook Kim, Seoul (KR); Hwa Jun Oh, Seoul (KR)

(73) Assignee: LG ELECTRONICS INC., Seoul (KR)

(21) Appl. No.: 16/579,181

(22) Filed: Sep. 23, 2019

(30) Foreign Application Priority Data
Aug. 12, 2019 (KR) 10-2019-0098364

(51) Int. Cl. G06Q 30/06; G06N 20/00; G06Q 30/02

(52) U.S. Cl. CPC G06Q 30/0629; G06Q 30/0283; G06N 20/00

(57) ABSTRACT

Disclosed is a trained model generating method and apparatus that assesses an acquisition price of a subscription product by executing an artificial intelligence (AI) algorithm or a machine learning algorithm in a 5G environment connected for the Internet of Things, and that reinforces a trained model by reflecting, as a reward, a result of suggesting to a user to acquire the product. A product price assessing method according to one embodiment of the present disclosure may include: applying at least one of user information, product information, or environment information, or preprocessed data thereof to a machine learning-based first trained model; and assessing a product price of a product related to the product information based on the first trained model. Reinforcement learning may be conducted to the first trained model by reflecting, as a reward, whether the user determines to acquire the product at the assessed product price.

### CROSS-REFERENCE TO RELATED APPLICATION

This present application claims benefit of priority to Korean Patent Application No. 10-2019-0098364, entitled “METHOD AND APPARATUS FOR ASSESSING PRICE FOR SUBSCRIPTION PRODUCTS,” filed on Aug. 12, 2019, in the Korean Intellectual Property Office, the entire disclosure of which is incorporated herein by reference.

### BACKGROUND

### 1. Technical Field

The present disclosure relates to a subscription product price assessing method and apparatus, and more particularly, to a subscription product price assessing method and apparatus capable of increasing an acquisition possibility of a subscription product, by assessing an acquisition price of a subscription product of a user via a machine learning method and then reinforcing a trained model by reflecting, as a reward, a result of suggesting to the user to acquire the product.

### 2. Description of Related Art

In recent years, as consumption habits and economic conditions of consumers change, systems and companies for subscribing to various products, such as home appliances, automobiles, and household goods, have been introduced. When a subscription period of a consumer using a subscription product expires, a typical system for the subscription product implements a policy that the user returns the corresponding subscription product to a subscription enterprise or that the user acquires the corresponding subscription product, when desired.

In particular, Related Art 1 and Related Art 2 disclose a technique that assesses a remaining balance for the corresponding subscription product and then adjusts a future subscription price for a consumer using the corresponding subscription product according to the remaining balance, or adjusts an acquisition price for the customer wanting to acquire the product.

Related Art 1 discloses a technique that, after a vehicle subscription is terminated, assesses a price, according to an occupation of a private customer or a type of business of a corporate customer, for the vehicle to be resold to a customer, and reflects the assessed price in determining the subscription price. However, Related Art 1 has a disadvantage in that the resell price of the vehicle is unable to be assessed differently for each user.

Related Art 2 discloses a technique that compares subscription product usage history (for example, maintenance history and accident history of a rental car) and subscription payment history of a customer with a predetermined criterion, and when the corresponding customer acquires the subscription product, lowers an installment plan interest rate or an acquisition price. However, Related Art 2 has a disadvantage in that, for example, the acquisition price is determined only by means of comparison with the predetermined criterion. Related Art 2 also has a disadvantage in that since whether the customer determines to acquire the product at the suggested installment plan interest rate or acquisition price when requesting to acquire the product is unable to affect the determining of the acquisition price when another customer requests to acquire the product, it is not possible to increase the acquisition possibility from beforehand when assessing the acquisition price to be suggested to the other customer.

The above-described background art is technical information retained by the inventor to derive the present disclosure or acquired by the inventor while deriving the present disclosure, and thus should not be construed as art that was publicly known prior to the filing date of the present disclosure.

Related Art 1: Korean Patent Application Publication No. 10-2010-012132 (published on Nov. 7, 2010)

Related Art 2: Korean Patent Application Publication No. 10-2014-013916 (published on Dec. 5, 2014)

One embodiment of the present disclosure is directed to providing an acquisition price assessing method capable of increasing an acquisition possibility of a user, based on user information, product status information, or environment information, via a machine learning technique, by addressing a limitation in the related art that was unable to reflect the user information, the product status information, or the environment information in assessing an acquisition price when the user acquires a product which the user had been using for a trial or a product to which the user is subscribed.

One embodiment of the present disclosure is directed to increasing an acquisition possibility by monitoring usage history for each trial or subscription product and reflecting the monitored usage history in assessing an acquisition price.

One embodiment of the present disclosure is directed to increasing an acquisition possibility by monitoring an extent of a user's interest in a trial or subscription product and reflecting the monitored extent of the user's interest in assessing an acquisition price.

One embodiment of the present disclosure is directed to providing a method for determining an acquisition suggestion time capable of increasing an acquisition possibility of a user, based on user information, product status information, or environment information, via a machine learning technique.

One embodiment of the present disclosure is directed to increasing acquisition possibilities of future users via reinforcement learning which reflects, as a reward, in a trained model for assessing an acquisition price in the future, whether a user determines to acquire, at a suggested acquisition price, a product which the user had been using for a trial or a product to which the user is subscribed, when the user acquires the product.

The present disclosure is not limited to what has been described above, and other aspects and advantages of the present disclosure will be understood by the following description and become apparent from the embodiments of the present disclosure. In addition, it will be understood that the objects and the advantages of the present disclosure can be realized by the means recited in claims and a combination thereof.

### SUMMARY OF THE INVENTION

A product price assessing method, according to one embodiment of the present disclosure, may reinforce a trained model by reflecting, as a reward, whether a user determines to acquire a product at an acquisition price assessed via the trained model.

Specifically, the product price assessing method according to one embodiment of the present disclosure may include applying at least one of user information, product information, or environment information, or preprocessed data thereof to a machine learning-based first trained model; and assessing a product price of a product related to the product information based on the first trained model. The first trained model is a model that has been previously trained to assess, based on at least one of the user information, the product information, or the environment information, a product price at which a user determines to acquire a product, and may reinforce a trained model by reflecting, as a reward, whether the user determines to acquire the product at the assessed product price.

It is possible to increase an acquisition possibility of a subscription product by performing reinforcement learning that rewards a trained model with an acquisition price at which a user determines to acquire the product or refuses to acquire the product, via the product price accessing method according to the present embodiment.

In addition, the product information may be information related to usage history or usage status of a product, and at least some of the product information may be based on information sensed by a sensor provided in the product.

It is possible to increase an acquisition possibility of a user for a subscription product by assessing an appropriate price and an acquisition suggestion time according to a real-time status of the subscription product of a user, via the product information according to the present embodiment.

In addition, the applying may include applying preprocessed data of product information generated from a plurality of different types of products, user information related to the plurality of products, and environment information, to the first trained model, and the assessing may include assessing a product price of each of the plurality of products.

It is possible to assess a price by reflecting statuses of subscription products of a user in a complex manner by applying product information of a plurality of products to the same trained model, via the applying according to the present embodiment.

In addition, a first trained model is a trained model that checks a correlation between the product information generated from a plurality of different types of products and then determines that the plurality of products having a correlation greater than or equal to a predetermined criterion belong to the same product family, and that is configured to assess product prices of the plurality of products belonging to the same product family by using a price assessing model preset for the corresponding product family.

It is possible to assess a price by reflecting statuses of subscription products of a user in a complex manner by applying, to the same trained model, product information determined as a similar type of product or related user information, via the trained model according to the present embodiment.

In addition, the user information may include at least one of a type, a model name, a price, a function, a search frequency, or a reading frequency of a product of interest searched or read by the user, and at least some of the user information may be based on information collected from a terminal of the user.

It is possible to improve a determining of an acquisition price and a determining of a suggestion time in a trained model by accurately parsing in real-time whether a user is interested in a subscription product or a similar product, via the user information according to the present embodiment.

In addition, the product price assessing method according to one embodiment of the present disclosure may further include determining whether to suggest to a user whether to acquire a product, by applying at least one of user information, product information, or environment information to a second trained model, wherein the second trained model is a trained model that has been previously trained to estimate a time of when the user is most likely to acquire the product, and is reinforced by reflecting, as a reward, whether the user determines to acquire the product with respect to an acquisition suggestion made at the estimated time.

It is possible to determine an acquisition price as well as a time capable of increasing an acquisition possibility of a subscription product, via the trained model according to the present embodiment.

According to a trained model generating and distributing method in a server according to one embodiment of the present disclosure, the server may transmit, to a user terminal, a trained model reinforced by reflecting, as a reward, whether a user determines to acquire a product at an acquisition price assessed via a trained model; may cause the user terminal to assess an acquisition price of a subscription product and to suggest the assessed acquisition price to the user; and may receive the result thereof from the user terminal.

Specifically, the trained model generating and distributing method according to one embodiment of the present disclosure may include training a machine learning-based trained model with preprocessed training data of at least one of user information, product information, or environment information; transmitting the trained model, which has been trained with preprocessed training data, to the user terminal; and reinforcing the trained model by receiving, from the user terminal, whether a user determines to acquire a product at a product price assessed based on the trained model, which has been trained with preprocessed training data, and by reflecting, as a reward, whether the user determines to acquire the product, wherein the training data is a data set having, as a label, a price at which the user acquired the product under a particular condition of at least one of the user information, the product information, or the environment information.

It is possible to reduce a load of a trained model server in assessing prices of subscription products for a plurality of users can be reduced and to improve security of the product information and the user information, via the trained model generating and distributing method according to the present embodiment.

In addition, the trained model generating and distributing method according to the present embodiment may further include receiving product list information which is set in the user terminal, wherein the training a trained model may include training the machine learning-based trained model with product information related to a product of the set product list information and the training data having, as the label, a price at which a user acquired the corresponding product.

It is possible to reflect statuses of subscription products of a user in a complex manner and assess a price based on a trained model that is trained for a private user, via the training data according to the present embodiment.

In addition, the trained model generating and distributing method according to the present embodiment may further include receiving user information which is set in the user terminal, wherein the training a trained model may include training the machine learning-based trained model with user information of a plurality of users determined as users according to the set user information and a predetermined criterion, and the training data having, as the label, the prices at which the plurality of users acquired a product.

It is possible to assess a price by accurately reflecting user tendency by applying user information of a plurality of users determined to be similar users to the same trained model, via the training data according to the present embodiment.

A product price assessing apparatus according to one embodiment of the present disclosure may reinforce a trained model by reflecting, as a reward, whether a user determines to acquire a product at an acquisition price assessed via the trained model.

Specifically, the product price assessing apparatus according to one embodiment of the present disclosure may include a memory configured to store at least one command and at least a portion of data related to a trained model; and a processor configured to execute the stored at least one command, wherein the processor is configured to assess a product price of a product related to the product information by applying preprocessed data of at least one of user information, product information, or environment information to the trained model that is based on machine learning, and wherein the trained model may be previously trained to assess, based on at least one of the user information, the product information, or the environment information, a product price at which a user determines to acquire a product, and may be reinforced by reflecting, as a reward, whether the user determines to acquire the product at the assessed product price.

A trained model generating and distributing apparatus according to one embodiment of the present disclosure may transmit, to a user terminal, a trained model reinforced by reflecting, as a reward, whether a user determines to acquire a product at an acquisition price assessed via the trained model, may cause the user terminal to assess an acquisition price of a subscription product and to suggest the assessed acquisition price to the user, and may receive the result thereof from the user terminal.

Specifically, the trained model generating and distributing apparatus according to one embodiment of the present disclosure may include a memory configured to store at least one command; and a processor configured to execute the stored at least one command, wherein the processor may be configured to train a machine learning-based trained model with preprocessed training data of at least one of user information, product information, or environment information, to transmit the trained model to a user terminal such that the user terminal assesses a product price of a product, to receive, from the user terminal, whether a user determines to acquire a product at a product price assessed based on the trained model, and to reinforce the trained model by reflecting, as a reward, whether the user determines to acquire the product. The training data may be a data set having, as a label, a price at which the user acquired the product under a particular condition of at least one of the user information, the product information, or the environment information.

It is possible to reduce a load of a trained model server in assessing prices of subscription products for a plurality of users, via the trained model generating and distributing apparatus according to the present embodiment.

A user terminal according to one embodiment of the present disclosure may improve security of product information of user-possessed products and user information, by receiving a trained model from a learning device and transmitting, to the learning device, a result of suggesting the received trained model to a user.

Specifically, the user terminal according to one embodiment of the present disclosure is a user terminal to which a machine learning-based trained model is applied, and may include a memory configured to store at least one command and parameters of a machine learning-based trained model; a communicator configured to receive the trained model from a learning device and to receive product information from at least one external electronic device; and a processor configured to apply preprocessed data of at least one of user information, product information, or environment information to the trained model, and to control the user terminal such that the user terminal displays, to a user, an interface related to a determining of an acquisition for a product related to the product information according to a result of assessing a price of the product based on the trained model, wherein the communicator may be configured to transmit, to the learning device, information related to whether the user determines to acquire the product, in order to reinforce the trained model by reflecting, as a reward, whether the user determines to acquire the product at the assessed product price.

It is possible to improve security of a product information related to a user-possessed product and a user information while reinforcing the trained model by reflecting, as a reward, whether a user determines to acquire a product, via the user terminal according to the present embodiment.

In addition to the aforementioned, other methods and other systems for implementing the present disclosure, and computer programs for implementing such methods, may be further provided.

Other aspects, features, and advantages will become apparent from the following drawings, claims, and detailed description of the invention.

According to one embodiment of the present disclosure, an acquisition price, which is capable of increasing an acquisition possibility of a user, can be assessed via a machine learning-based trained model that is trained based on user information of various users, status information of various products, or environment information.

In addition, according to one embodiment of the present disclosure, an acquisition suggestion time, which is capable of increasing an acquisition possibility of a user, can be estimated, via a machine learning-based trained model that is trained based on user information of various users, status information of various products, or environment information.

In addition, according to one embodiment of the present disclosure, before a product subscription period ends or during a trial period of a user, an acquisition price and a time at which the user is likely to acquire the subscription product can be assessed, thereby promoting sales of products.

In addition, according to one embodiment of the present disclosure, an acquisition possibility can be increased via reinforcement learning that reflects, as a reward, in a trained model capable of assessing an acquisition price, whether a customer determines to acquire a product at a suggested acquisition price.

In addition, according to one embodiment of the present disclosure, an acquisition suggestion time can be determined which is capable of increasing an acquisition possibility, via reinforcement learning that reflects, as a reward, in a trained model capable of assessing an acquisition time, whether a customer determines to acquire a product.

The effects of the present disclosure are not limited to those mentioned above, and other effects not mentioned can be clearly understood by those skilled in the art from the following description.

### BRIEF DESCRIPTION OF THE DRAWINGS

FIG. 1 is a block diagram illustrating a configuration of a terminal 100 according to one embodiment of the present disclosure.

FIG. 2 is a block diagram illustrating a configuration of a learning device 200 of an artificial neural network according to one embodiment of the present disclosure.

FIG. 3 is a view illustrating an environment for generating a trained model and assessing a product price according to one embodiment of the present disclosure.

FIG. 4 is a view illustrating an environment for generating and distributing a trained model and assessing a product price according to one embodiment of the present disclosure.

FIG. 5 is a flowchart illustrating operations of a product price assessing and reinforcement learning method according to one embodiment of the present disclosure.

FIG. 6 is a flowchart illustrating operations of a trained model generating and distributing method for assessing a product price and a reinforcement learning method according to one embodiment of the present disclosure.

### DETAILED DESCRIPTION

Hereinafter, embodiments of the present disclosure will be described in detail with reference to the accompanying drawings. Like reference numerals refer to the like elements throughout and a duplicate description thereof is omitted. Suffixes “module” and “unit or portion” for elements used in the following description are merely provided for facilitation of preparing this specification, and thus they are not granted a specific meaning or function. Wherever possible, the same reference numbers will be used throughout the drawings to refer to the same or like parts. In the following description, known functions or structures, which may confuse the substance of the present disclosure, are not explained. The accompanying drawings are used to help easily explain various technical features and it should be understood that the embodiments presented herein are not limited by the accompanying drawings. As such, the present disclosure should be construed to extend to any alterations, equivalents and substitutes in addition to those which are particularly set out in the accompanying drawings.

Although the terms first, second, and the like, may be used herein to describe various elements, these elements should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

Artificial intelligence (AI) is a field of computer engineering and information technology that researches a method for the computer to enable thinking, learning, self-development, etc. which are possible by human's intelligence, and means that the computer can imitate human's intelligent behavior.

In addition, the Artificial Intelligence does not exist in itself, but has many direct and indirect links with other fields of computer science. In recent years, there have been numerous attempts to introduce an element of AI into various fields of information technology to solve problems in the respective fields.

Machine Learning is a field of Artificial Intelligence, and a field of research that gives the ability capable of learning without an explicit program in the computer.

Specifically, the Machine Learning can be a technology for researching and constructing a system for learning, predicting, and improving its own performance based on empirical data and an algorithm for the same. The algorithms of the Machine Learning take a method of constructing a specific model in order to obtain the prediction or the determination based on the input data, rather than performing the strictly defined static program instructions.

Many Machine Learning algorithms have been developed on how to classify data in the Machine Learning. Decision Tree, Bayesian network, Support Vector Machine (SVM), Artificial Neural Network (ANN), etc. are representative examples.

The Decision Tree is an analytical method that performs classification and prediction by plotting a Decision Rule in a tree structure.

The Bayesian network is a model of the probabilistic relationship (conditional independence) between multiple variables in a graphical structure. The Bayesian network is suitable for data mining through Unsupervised Learning.

The Support Vector Machine is a model of Supervised Learning for pattern recognition and data analysis, and mainly used for classification and regression.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training

The terms ‘artificial neural network’ and ‘neural network’ may be used interchangeably herein.

An ANN may include a number of layers, each including a number of neurons. In addition, the Artificial Neural Network can include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a lower layer.

The Artificial Neural Network can include network models of the method such as Deep Neural Network (DNN), Recurrent Neural Network (RNN), Bidirectional Recurrent Deep Neural Network (BRDNN), Multilayer Perceptron (MLP), and Convolutional Neural Network (CNN), but is not limited thereto.

The terms “layer” and “hierarchy” may be used interchangeably herein.

An ANN may be classified as a single-layer neural network or a multi-layer neural network, based on the number of layers therein.

In general, a single-layer neural network may include an input layer and an output layer.

In addition, a general Multi-Layer Neural Network is composed of an Input layer, at least one Hidden layers, and an Output layer.

The Input layer is a layer that accepts external data, the number of neurons in the Input layer is equal to the number of input variables, and the Hidden layer is disposed between the Input layer and the Output layer and receives a signal from the Input layer to extract the characteristics to transfer it to the Output layer. The output layer receives a signal from the hidden layer and outputs an output value based on the received signal. The Input signal between neurons is multiplied by each connection strength (weight) and then summed, and if the sum is larger than the threshold of the neuron, the neuron is activated to output the output value obtained through the activation function.

Meanwhile, the Deep Neural Network including a plurality of Hidden layers between the Input layer and the Output layer can be a representative Artificial Neural Network that implements Deep Learning, which is a type of Machine Learning technique.

The Artificial Neural Network can be trained by using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data can classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning at least one label to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In such a case, the training data can represent the feature of the input object in the form of a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

The Reinforcement Learning can be mainly performed by a Markov Decision Process (MDP).

Explaining the Markov Decision Process, firstly, the environment in which the agent has the necessary information to do the following actions is given, secondly, it is defined how the agent behaves in the environment, thirdly, i it is defined how to give reward or penalty to the agent, and fourthly, the best policy is obtained by repeatedly experiencing until the future reward reaches its peak.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size. Momentum and NAG in SGD may include a method that increases optimization accuracy by adjusting the step size. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good trained model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

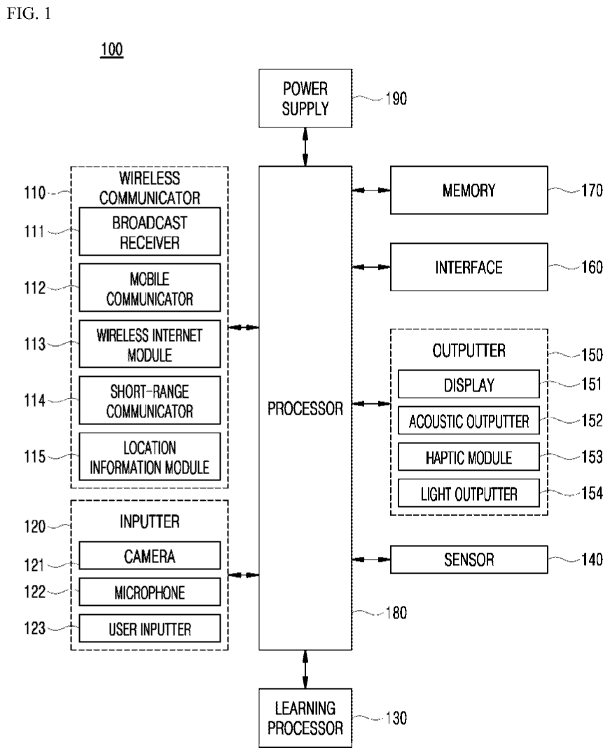

FIG. 1 is a block diagram illustrating a configuration of a terminal 100 according to one embodiment of the present disclosure.

The terminal 100 may be implemented as a stationary terminal and a mobile terminal, such as a mobile phone, a projector, a smartphone, a laptop computer, a terminal for digital broadcast, a personal digital assistant (PDA), a portable multimedia player (PMP), a navigation system, a slate PC, a tablet PC, an ultrabook, a wearable device (for example, a smartwatch, a smart glass, and a head mounted display (HMD)), a set-top box (STB), a digital multimedia broadcast (DMB) receiver, a radio, a washing machine, a refrigerator, a desktop computer, and digital signage.

Further, the terminal 100 may be implemented as various forms of home appliances, and may be also applied to a stationary or mobile robot.

The terminal 100 may perform a function of an voice agent. The voice agent may be a program configured to recognize a voice of a user and output a voice corresponding to the voice of the user.

Referring to FIG. 1, the terminal 100 may include a wireless communicator 110, an inputter 120, a learning processor 130, a sensor 130, an outputter 150, an interface 160, a memory 170, a processor 180, and a power supply 190.

A trained model may be provided in the terminal 100.

Meanwhile, the trained model may be implemented as hardware, software, or a combination of hardware and software, and in cases where the trained model is partially or entirely implemented as software, at least one command constituting the trained model may be stored in the memory 170.

The wireless communicator 110 may include at least one selected from a broadcast receiver 111, a mobile communicator 112, a wireless Internet module 113, a short-range communicator 114, or a location information module 115.

The broadcast receiver 111 receives broadcast signals or broadcast-related information via a broadcast channel from an external broadcast management server.

The mobile communicator 112 may transmit/receive a wireless signal to/from at least one of a base station, an external terminal, or a server on a mobile communication network established according to the technical standards or communication methods for mobile communication (for example, Global System for Mobile communication (GSM), code division multi access (CDMA), code division multi access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The wireless Internet module 113 refers to a module for wireless Internet access and may be built in or external to the terminal 100. The wireless Internet module 113 may be configured to transmit/receive a wireless signal in a communication network according to wireless Internet technologies.

The wireless Internet technologies are, for example, Wireless LAN (WLAN), Wireless-Fidelity (Wi-Fi), Wireless Fidelity (Wi-Fi) Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A).

The short-range communicator 114 is for short-range communication, and may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, or Wireless Universal Serial Bus (USB) technologies.

The location information module 115 is a module for obtaining the location of a mobile terminal, and representative examples of the mobile terminal include a global positioning system (GPS) module or a Wi-Fi module. For example, the location of the mobile terminal may be obtained by using a signal transmitted from a GPS satellite via the GPS module.

The inputter 120 may include a camera 121 for inputting an image signal, a microphone 122 for receiving an audio signal, and a user inputter 123 for receiving information inputted from a user.

Voice data or image data collected by the inputter 120 may be analyzed and processed as a user's control command.

The inputter 120 may obtain, for example, training data for model training and input data to be used to obtain output by using a trained model.

The inputter 120 may obtain unprocessed input data and in this case, the processor 180 or the learning processor 130 may preprocess the obtained data and generate training data or preprocessed input data which can be inputted for model training

Here, the preprocessing of input data may refer to extracting an input feature from the input data.

The inputter 120 is for inputting image information (or signal), audio information (or signal), data, or information being inputted by a user. As an example of inputting of the image information, the terminal 100 may be provided with at least one camera 121.

The camera 121 processes video frames, such as still images and moving images, which are obtained by an image sensor in a video communication mode or a photographing mode. The processed video frames may be displayed on a display 151 or stored in the memory 170.

The microphone 122 converts an external acoustic signal into electrical speech data. The converted speech data may be utilized in various manners according to a function (or an application program being executed) being performed in the terminal 100. The microphone 122 may implement various noise removal algorithms for removing noise generated in the process of receiving the external acoustic signal.

The user inputter 123 is for receiving information being inputted by a user. When the information is inputted via the user inputter 123, the processor 180 may control the terminal 100 such that the operation of the terminal 100 corresponds to the inputted information.

The user inputter 123 may include a mechanical type input tool (or a mechanical key, such as a button located on a front or rear surface or a side surface of the terminal 100, a dome switch, a jog wheel, and a jog switch) and a touch type input tool. As an example, the touch type input tool may include a virtual key, a soft key, or a visual key displayed on a touch screen via software processing, or may include a touch key disposed on any portion other than the touch screen.

The learning processor 130 trains a model consisting of an artificial neural network by using training data.

More specifically, the learning processor 130 may repeatedly train the artificial neural network by using various training schemes described above to determine optimized model parameters of the artificial neural network.

Throughout the present specification, the artificial neural network of which parameters are determined by being trained using training data may be referred to as a trained model.

Here, the trained model may be used to infer a result value with respect to new input data rather than training data.

The learning processor 130 may be configured to receive, classify, store, and output information to be used for data mining, data analysis, intelligent decision making, and machine learning algorithms and techniques.

The learning processor 130 may include at least one memory configured to store data received, detected, sensed, generated, predefined, or outputted by other component, device, terminal, or apparatus in communication with the terminal.

The learning processor 130 may include a memory integrated or implemented in the terminal. In some embodiments, the learning processor 130 may be implemented by using the memory 170.

Alternatively or additionally, the learning processor 130 may be implemented by using a memory related to the terminal, such as an external memory directly coupled to the terminal or a memory maintained in a server in communication with the terminal.

In another embodiment, the learning processor 130 may be implemented by using a memory maintained in a cloud computing environment, or another remote memory location accessible by the terminal via a communications method such as a network.

In general, the learning processor 130 may be configured to store data in at least one database in order to identify, index, categorize, manipulate, store, search, and output the data to be used for supervised or non-supervised learning, data mining, predictive analysis, or used in another machine. Here, the database may be implemented using the memory 170, a memory 230 of a learning device 200, a memory maintained in a cloud computing environment, or another remote memory location accessible by the terminal via a communications method such as a network.

Information stored in the learning processor 130 may be used by at least one other controller of the terminal or the processor 180 by using one of various different types of data analysis algorithms and machine learning algorithms.

As an example of such an algorithm, a k-nearest neighbor system, fuzzy logic (for example, a possibility theory), a neural network, a Boltzmann machine, vector quantization, a pulse neural network, a support vector machine, a maximum margin classifier, hill climbing, an inductive logic system, a Bayesian network, (for example, a finite state machine, a Mealy machine, and a Moore finite state machine), a classifier tree (for example, a perceptron tree, a support vector tree, a Markov Tree, a decision tree forest, and an arbitrary forest), a read model and system, artificial fusion, sensor fusion, image fusion, reinforcement learning, augmented reality, pattern recognition, and automated planning may be provided.

The processor 180 may determine or predict at least one executable operation of the terminal based on information generated or determined by using a data analysis and a machine learning algorithm. To this end, the processor 180 may request, retrieve, receive, or utilize the data from the learning processor 130, and may control the terminal such that the terminal performs a predicted operation or desirable operation of the at least one executable operation.

The processor 180 may perform various functions to implement intelligent emulation (that is, a knowledge based system, an inference system, and a knowledge acquisition system). This may be applied to various types of systems (for example, fuzzy logic systems), including, for example, adaptive systems, machine learning systems, and artificial neural networks.

The processor 180 may also include submodules that enable operations involving speech and natural language speech processing, such as an I/O processing module, an environment condition module, a Speech to Text (STT) processing module, a natural language processing module, a workflow processing module, and a service processing module.

Each of these submodules may have access to at least one system or data and models at the terminal, or a subset or superset thereof. In addition, each of these submodules may provide various functions, including a vocabulary index, user data, a workflow model, a service model, and an automatic speech recognition (ASR) system.

In another embodiment, other aspects of the processor 180 or the terminal may be implemented with the submodule, system, or data and model.

In some examples, based on data from the learning processor 130, the processor 180 may be configured to identify and detect a requirement, based on contextual condition or user intent represented by a user input or a natural language input.

The processor 180 may actively derive and obtain information to be used to fully determine the requirement based on the contextual condition or user intent. For example, the processor 180 may actively derive information to be used to determine the requirement by analyzing historical data including, for example, historical inputs and outputs, pattern matching, unambiguous words, and input intent.

The processor 180 may determine a task flow for executing a function responding to the requirement based on the contextual condition or user intent.

The processor 180 may be configured to collect, sense, extract, detect, or receive, by at least one sensing component of the terminal, signal or data to be used in data analysis and machine learning operation, in order to collect information for processing and storing in the learning processor 130.

The collecting information may include detecting information via a sensor, extracting information stored in the memory 170, or receiving information from another terminal, entity, or external storage device via a communication means.

The processor 180 may collect usage history information in the terminal, and store the information in the memory 170.

The processor 180 may use the stored usage history information and prediction modeling to determine the best match for executing a specific function.

The processor 180 may receive or detect the environment information or other information via a sensor 140.

The processor 180 may receive a broadcast signal or broadcast-related information, a wireless signal, or wireless data via the wireless communicator 110.

The processor 180 may receive image information (or a corresponding signal), audio information (or a corresponding signal), data or user input information from the inputter 120.

The processor 180 may collect information in real-time, process or classify the information (for example, knowledge graph, command policy, personalization database, and dialog engine), and store the processed information in the memory 170 or the learning processor 130.

When the operation of the terminal is determined based on a data analysis and a machine learning algorithm and technique, the processor 180 may control components of the terminal such that the components perform the determined operation. Subsequently, the processor 180 may control the terminal such that the terminal performs the determined operation according to the control command.

When a specific operation is performed, the processor 180 may analyze history information indicating the execution of the specific operation via the data analysis and the machine learning algorithm and technique, and perform an update of previously trained information based on the analyzed information.

Therefore, the processor 180, along with the learning processor 130, may improve the accuracy of the future performance of the data analysis and the machine learning algorithm and technique based on the updated information.

The sensor 140 may include at least one sensor for sensing at least one of information related to the mobile terminal, information on an environment surrounding the the mobile terminal, or user information.

For example, the sensor 140 may include at least one of a proximity sensor, an illumination sensor, a touch sensor, an acceleration sensor, a magnetic sensor, a gravitational sensor (G-sensor), a gyroscope sensor, a motion sensor, an RGB sensor, an infrared sensor (IR sensor), a finger scan sensor, an ultrasonic sensor, an optical sensor (see, for example, camera 121), a microphone (see microphone 122), a battery gauge, an environment sensor (for example, a barometer, a hygrometer, a thermometer, a radiation detection sensor, a heat detection sensor, and a gas detection sensor), or a chemical sensor (for example, an electronic nose, a healthcare sensor, and a biometric sensor). The terminal disclosed herein may combine and utilize information sensed by at least two sensors among these sensors.

The outputter 150 is for generating an output such as a visual output, an audible output, or a haptic output, and may include at least one of a display 151, an acoustic outputter 152, a haptic module 153, or a light outputter 154.

The display 151 is configured to display (output) information processed in the terminal 100. For example, the display 151 may display execution screen information on the application program executed in the terminal 100, or user interface (UI) or graphic user interface (GUI) information according to the execution screen information.

Since the display 151 may form a mutually layered structure with the touch sensor or may be formed integrally with the touch sensor, the display 151 may implement a touch screen. This touch screen may function as the user inputter 123 to provide an input interface between the terminal 100 and the user, and at the same time may provide an output interface between the terminal 100 and the user.

The acoustic outputter 152 may be configured to output audio data received from the wireless communicator 110 or stored in the memory 170, for example, in a call signal reception mode, a call mode, a record mode, a speech recognition mode, and a broadcast receiver mode.

The acoustic outputter 152 may include at least one of a receiver, a speaker, or a buzzer.

The haptic module 153 is configured to generate various haptic effects that the user can feel. A representative example of the haptic effects generated by the haptic module 153 may include vibration.

The light outputter 154 is configured to output a signal for notifying an occurring event by using light from a light source of the terminal 100. Examples of the event capable of occurring in the terminal 100 may include, for example, message reception, call signal reception, missed call, alarm, schedule notification, email reception, and reception of information via an application.

The interface 160 is configured to serve as a path for connection between the terminal 100 and various types of external devices. This interface 160 may include at least one of a wired/wireless headset port, an external charger port, a wired/wireless data port, a memory card port, a port for connecting a device having an identification module, an audio input/output (I/O) port, a video input/output (I/O) port, or an earphone port. In response to an external device being connected to the interface 160, the terminal 100 may control the connected external device.

The identification module is a chip for storing various types of information for authenticating the authority for use of the terminal 100, and may include, for example, a user identify module (UIM), a subscriber identity module (SIM), and a universal subscriber identity module (USIM). The device having the identification module (hereinafter referred to as “identification device”) may be manufactured in the form of a smart card. Accordingly, the identification device may be connected to the terminal 100 through the interface 160.

The memory 170 stores data for supporting various functions of the terminal 100.

The memory 170 may store a plurality of application programs (or applications) executed in the terminal 100, data for operating the terminal 100, commands, and data for operating the learning processor 130 (for example, at least one algorithm information for machine learning).

The memory 170 may store a model trained by the learning processor 130 or the learning device 200.

Here, the memory 170 may classify the trained model into a plurality of versions depending on, for example, training time or training progress, when necessary, and may store the classified trained model.

Here, the memory 170 may store, for example, input data obtained by the inputter 120, learning data (or training data) used for model training, and training history of a model.

Here, the input data stored in the memory 170 may be data suitably processed for model training, as well as unprocessed input data itself.

The processor 180 normally controls the overall operation of the terminal 100, in addition to the operations associated with the application program. The processor 180 may provide the user with appropriate information or functions, or may process the information or functions by processing, for example, signals, data, and information inputted or outputted via the above-mentioned components or by executing the application program stored in the memory 170.

In addition, the processor 180 may control at least some of the components shown in FIG. 1 such that the application program stored in the memory 170 is executed. In addition, the processor 180 may operate at least two of the components included in the terminal 100 in combination to execute the application program.

As described above, the processor 180 normally controls the overall operation of the terminal 100, in addition to the operations associated with the application program. For example, when the status of the terminal satisfies a predetermined condition, the processor 180 may execute a lock status to prevent the user from inputting a control command for the applications, or may release the lock status.

Under the control of the processor 180, the power supply 190 is supplied with external power or internal power, and supplies power to each component included in the terminal 100. This power supply 190 may include a battery, which may be an internal battery or a replaceable battery.

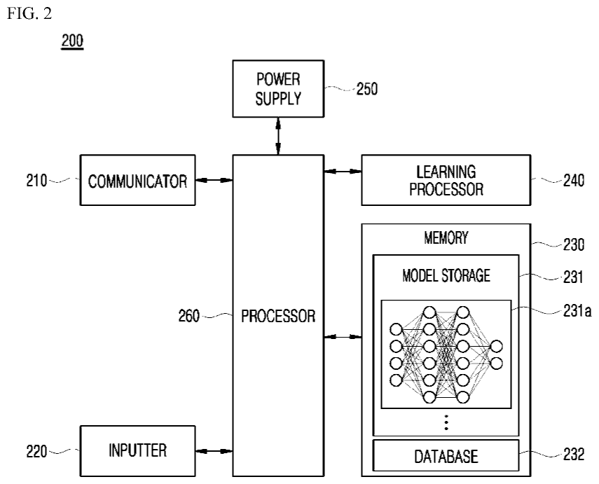

FIG. 2 is a block diagram illustrating a configuration of the learning device 200 of an artificial neural network according to one embodiment of the present disclosure.

The learning device 200 may be a device or a server separately configured outside the terminal 100, and may perform the same function as the learning processor 130 of the terminal 100.

That is, the learning device 200 may be configured to receive, classify, store, and output information to be used for data mining, data analysis, intelligent decision making, and machine learning algorithms. Here, the machine learning algorithm may include a deep learning algorithm.

The learning device 200 may communicate with at least one terminal 100, and may analyze or learn data on behalf of the terminal 100 or by assisting the terminal 100 to derive a result. Here, the assisting another device may refer to a distribution of computing power by distributed processing.

The learning device 200 of the artificial neural network may be various devices for training the artificial neural network, may usually refer to a server, and may be referred to as, for example, a learning device or a learning server.

In particular, the learning device 200 may be implemented as not only a single server, but also, for example, a plurality sets of servers, a cloud server, or combinations thereof.

That is, a plurality of learning devices 200 may constitute a set of learning devices (or a cloud server), and at least one learning device 200 included in the set of learning devices may analyze or learn data by distributed processing to derive a result.

The learning device 200 may transmit the model trained by machine learning or deep learning to the terminal 100 in a periodical manner or upon request.

Referring to FIG. 2, the learning device 200 may include, for example, a communicator 210, an inputter 220, a memory 230, a learning processor 240, a power supply 250, and a processor 260.

The communicator 210 may correspond to a configuration including the wireless communicator 110 and the interface 160 shown in FIG. 1. That is, the communicator 210 may transmit/receive data to/from another device via a wired/wireless communication or an interface.

The inputter 220 is a component corresponding to the inputter 120 shown in FIG. 1, and may receive data via the communicator 210.

The inputter 220 may obtain, for example, training data for model training and input data for obtaining an output using the trained model.

The inputter 220 may obtain unprocessed input data and in this case, the processor 260 may preprocess the obtained data to generate training data or preprocessed input data which may be inputted for model training

Here, the preprocessing of the input data performed in the inputter 220 may refer to extracting an input feature from the input data.

The memory 230 is a component corresponding to the memory 170 shown in FIG. 1.

The memory 230 may include, for example, a model storage 231 and a database 232.

The model storage 231 stores a model (or an artificial neural network 231a) which is being trained or has been trained through the learning processor 240. When a model is updated via learning, the model storage 231 stores an updated model.

Here, the model storage 231 may classify the trained model into a plurality of versions depending on, for example, training time or training progress, when necessary, and may store the classified trained model.

The artificial neural network 231a shown in FIG. 2, is provided as one example of an artificial neural network including a plurality of hidden layers. Accordingly, the artificial neural network according to one embodiment of the present disclosure is not limited thereto.

The artificial neural network 231a may be implemented as hardware, software, or a combination of hardware and software. When the artificial neural network 231a is partially or completely implemented as software, at least one command, which constitutes the artificial neural network 231a, may be stored in the memory 230.

The database 232 stores, for example, input data obtained by the inputter 220, learning data (or training data) used to model training, and training history of a model.

The input data stored in the database 232 may be not only data suitably processed for model training but also unprocessed input data itself.

The learning processor 240 is a component corresponding to the learning processor 130 shown in FIG. 1.

The learning processor 240 may train the artificial neural network 231a by using training data or a training set.

The learning processor 240 may train the artificial neural network 231a by immediately obtaining preprocessed data of the input data that the processor 260 obtains through the inputter 220, or may train the artificial neural network 231a by obtaining preprocessed input data stored in the database 232.

Specifically, the learning processor 240 may repeatedly train the artificial neural network 231a by using various training schemes described above to determine optimized model parameters of the artificial neural network 231a.

Throughout the present specification, the artificial neural network of which parameters are determined by being trained using the training data may be referred to as a trained model.

Here, the trained model may infer result values while being installed in the learning device 200 of the artificial neural network, and may be transmitted to and installed in another device such as the terminal 100 via the communicator 210.

In addition, when the trained model is updated, the updated trained model may be transmitted to and installed in another device such as the terminal 100 via the communicator 210.

The power supply 250 is a component corresponding to the power supply 190 shown in FIG. 1.

Descriptions regarding the components corresponding to each other will be omitted.

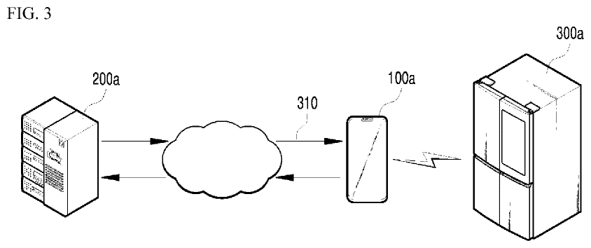

FIG. 3 is a view illustrating an environment for generating a trained model and assessing a product price according to one embodiment of the present disclosure. In the following description, a description overlapping with those of FIGS. 1 and 2 will be omitted. Referring to FIG. 3, the environment for generating the trained model and assessing the product price according to one embodiment may include a user terminal 100a, a product price assessing apparatus 200a corresponding to a machine learning-based electronic device, a user-possessed product 300a, and a network for connecting these with each other.

According to one embodiment, the user terminal 100a may include the same configuration as that shown in FIG. 1, receive product information related to usage history or usage status of the user-possessed product 300a, via the short-range communicator 114 from the user-possessed product 300a in a periodical or non-periodical manner, and process or not process the product information and then transmit it to the product price assessing apparatus 200a. Only one user-possessed product 300a is shown in FIG. 3 for convenience. However, according to a user environment, when the user retains a plurality of user-possessed products 300a, it is apparent that the user terminal 100a may receive, from the plurality of user-possessed products 300a, usage statuses thereof.

According to one embodiment, the usage status of the user-possessed product 300a may vary for each product type. For example, in the case of a refrigerator, the usage status may be, for example, total usage time of the refrigerator and the number of times the door had been opened. In addition, in the case of an air cleaner, the usage status may be, for example, total usage time of the air cleaner, usage time of an air cleaning filter, and usage mode information of the air cleaner. In the case of a washing machine, the usage status may be, for example, total usage time of the washing machine, usage mode information of the washing machine, and motor rotation speed. In the case of a vacuum cleaner, the usage status may be, for example, total usage time of the vacuum cleaner, usage mode information of the vacuum cleaner, and motor rotation speed.

According to one embodiment, the user terminal 100a may process the product information received from the user-possessed product 300a. As examples, a daily average usage time may be calculated from the total usage time of the product, total power consumption of the product may be calculated from the usage mode information and usage time of the product, or remaining battery life may be calculated from the total usage time of the product.

According to one embodiment, the user-possessed product 300a may sense product information from sensors used to monitor the product information, for example, a door opening detection sensor of the refrigerator, a temperature detection sensor of the refrigerator, a timer, a battery voltmeter/ammeter of a wireless vacuum cleaner, and a motor ammeter of the vacuum cleaner, the washing machine, or the air cleaner. Alternatively, the user-possessed product 300a may parse the product information from control signals of a micro controller unit (MCU) and store the product information in the memory, and then transmit the product information to the terminal 100a in a periodical or non-periodical manner.

In addition, according to another embodiment, the user-possessed product 300a may transmit the sensed or parsed product information to a separate home Internet of Things (IoT) server (not shown), such as a home speaker and a home PC. The home IoT server may transmit the collected product information together with the information specific to terminal 100a, information specific to the product, or the information specific to the user to the product price assessing apparatus 200a.

The product price assessing apparatus 200a may receive at least one of user information, product information related to usage history or usage status of the product, or environment information from the user terminal 100a, the user-possessed product 300a, or the home IoT server, and store in the memory 230, at least one of the user information, the product information, or the environment information, or at least one of preprocessed or other processed information thereof.

The processor 260 of the product price assessing apparatus 200a may execute commands stored in the memory 230 such that it inputs, to the trained model 231a, at least one of the user information, the product information related to the usage history or related to usage status of the product, or the environment information; or at least one of processed information thereof, and assesses the product price. The trained model for assessing the product price will be described in detail below.

The product price assessing apparatus 200a may transmit the assessed product price 310 to the user terminal 100a. The user terminal 100a may suggest the assessed product price 310 to the user via a user interface (UI), and suggest to the user whether to acquire a subscription or trial product at the suggested product price.

The user terminal 100a may transmit, to the product price assessing apparatus 200a and a commerce server for purchasing, whether the user determines to acquire a product at the product price assessed by the product price assessing apparatus 200a.

According to one embodiment, the product price assessing apparatus 200a may reinforce the trained model by reflecting, as a reward, whether the user determines to acquire a product at the assessed product price.

Therefore, the trained model can increase the acquisition possibility of future users for the subscription product, by continuous reinforcement based on the results of whether a plurality of users determine to acquire the product.

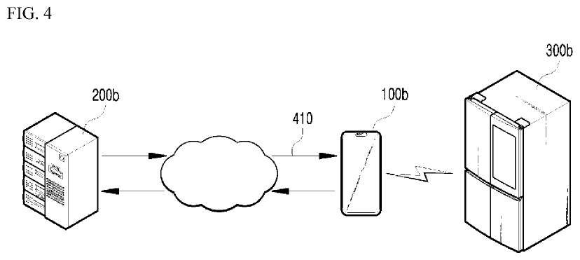

FIG. 4 is a view illustrating an environment for generating/distributing a trained model and assessing a product price according to another embodiment of the present disclosure. In the following description, a description overlapping with those of FIGS. 1 to 3 will be omitted. A trained model generating and distributing apparatus 200b corresponding to a machine learning-based electronic device according to FIG. 4 may be similar in some configurations to the product price assessing apparatus 200a of FIG. 3 described above, and may include some configurations of FIG. 2. Referring to FIG. 4, the environment for generating the trained model and assessing the product price according to one embodiment may include a user terminal 100b, the trained model generating and distributing apparatus 200b corresponding to the machine learning-based electronic device, a user-possessed product 300b, and a network for connecting these with each other.

The processor 260 of the generating and distributing apparatus 200b may execute commands stored in the memory 230, such that it trains the trained model with training data including: at least one of user information, product information related to the usage history or related to usage status of the product, or environment information; or at least one of preprocessed or other processed information thereof, and transmits the trained model 410 trained for assessing the product price, to the user terminal 100b.

The user terminal 100b according to FIG. 4 may be similar in some configurations to the user terminal 100a of FIG. 3 described above, and may include some configurations of FIG. 1.

According to one embodiment, the user terminal 100b may receive product information related to usage history or usage status of the user-possessed product 300b via the short-range communicator 114 from the user-possessed product 300b in a periodical or non-periodical manner, and may or may not process the product information. Subsequently, the user terminal 100b may assess the product price by applying the product information to a trained model received from the generating and distributing apparatus 200b and stored in the memory 170. Only one user-possessed product 300b is shown in FIG. 4 for convenience. However, according to a user environment, when the user retains a plurality of user-possessed products 300b, it is apparent that the user terminal 100b may receive, from the plurality of user-possessed products 300b, usage statuses thereof.

According to one embodiment, the processor 180 of the user terminal 100b may suggest to the user on a user interface via the outputter 150, the product price assessed by applying the user information, the product information, or the environment information to the trained model stored in the memory 170, such that the processor 180 may suggest to the user whether to acquire the user-possessed product 300b at the suggested product price.

According to another embodiment, before or after assessing the product price by applying the user information, the product information, or the environment information to the trained model stored in the memory 170, the processor 180 of the user terminal 100b may determine, via the trained model, whether to suggest to the user to acquire a user-possessed subscription product 300b, before suggesting the assessed price to the user. That is, the trained model may be a trained model that is previously trained to estimate, based on at least one of the user information, the product information, or the environment information, a time of when the user is most likely to acquire the product. The trained model for assessing the product price, and the trained model for determining whether to suggest to the user whether to acquire the subscription product (or, for determining a time for suggesting, in other words, a time of when the acquisition possibility is highest) may be the same or different. When being different, the user terminal 100b may receive, from the generating and distributing apparatus 200b, the trained model that had been previously trained to estimate the time of when the user is most likely to acquire the product.

According to one embodiment, the user terminal 100b may determine whether to suggest to the user whether to acquire the subscription product in a periodical or non-periodical manner based on the trained model, or may determine whether to suggest to the user whether to acquire the subscription product when any one of the user information, the product information, or the environment information changes to a predetermined criterion or greater. For example, when the usage time of a user (product information) increases rapidly, the number of buyers having the same gender as the user (environment information) increases rapidly, or the search frequency of the user for a similar product (user information) increases rapidly, it may be determined whether to suggest to the user whether to acquire the subscription product.

According to one embodiment, the environment information may include, for example, a change in wholesale or retail price of the product, information related to buyers of the product (for example, age, gender, region, and number), search history for the product via the Internet, and statistical sales volume for the product classified by time.

According to one embodiment, the user terminal 100b may transmit, to the generating and distributing apparatus 200b and the commerce server for purchasing, the assessed product price and whether the user determines to acquire a product at the assessed product price.

According to one embodiment, the generating and distributing apparatus 200b may reinforce the trained model transmitted to the user terminal 100b, by reflecting, as a reward, whether the user determines to acquire a product at the product price assessed by the user terminal 100b. When the trained model changes, the generating and distributing apparatus 200b may retransmit the changed trained model or related parameters (for example, a threshold value, a weighting value, a transfer function, and a neural network structure) to the user terminal 100b, and the user terminal 100 may then assess the product price based on the changed trained model.

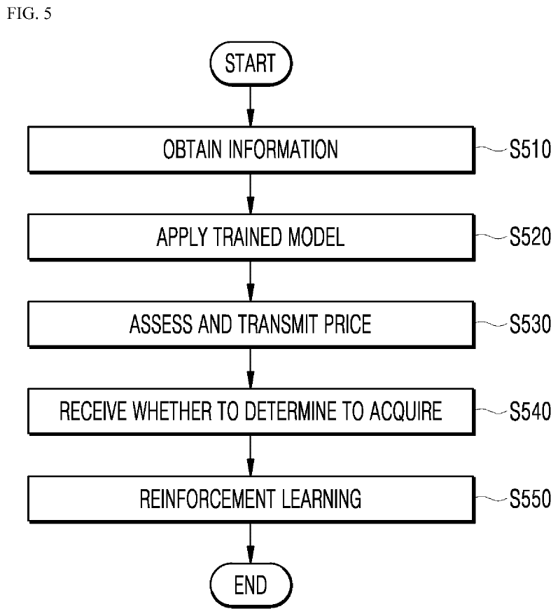

FIG. 5 is a flowchart illustrating operations of a product price assessing and reinforcement learning method of the product price assessing apparatus 200a corresponding to the machine learning-based electronic device shown in FIG. 3. In the following description, a description overlapping with those of FIGS. 1 to 4 will be omitted.

Referring to FIG. 5, in step S510, the product price assessing apparatus 200a may receive, from the user terminal 100a or a separate home IoT server (not shown), at least one of user information, product information, or environment information which the user terminal 100a or the separate home IoT server receives from, for example, user-possessed products. The information described above may be preprocessed information.

According to one embodiment, the preprocessing may include but is not limited to, for example, processing of missing value for obtained information, processing of categorical variables, and scaling.

According to one embodiment, the user information is information related to a user using a product for which an acquisition price is to be assessed, and may include personal information of the user, such as gender, age, occupation, and residence.

According to another embodiment, the user information may include, for example, types, model names, reading time, search or reading frequency, and product of interest setting of products which are searched or read on a subscription membership application installed in the user terminal 100a.

According to another embodiment, the user information may include, for example, types, model names, and search frequency of the same or similar class of products searched on an Internet search engine of the user terminal 100a, and corresponding user information may be collected using information associated with sessions, continuous browser cookies, and an integrated login account (for example, Google and Facebook account) of the corresponding user.

According to one embodiment, the environment information may include, for example, new product sales price information, sales volume/ranking by country/region, genders of buyers, and ages of buyers for a product identical or similar to a product for which an acquisition price is to be assessed.

According to one embodiment, the product information may include product information related to usage history or usage status obtained from product as described above.

According to another embodiment, the product information may include after service (A/S) history of a manufacturer, repair history of a separate repair organization, or appearance information with respect to a product. The appearance information may be determined and graded by a person such as a repairman, or determined by a machine learning-based visual determination device.

In step S520, the product price assessing apparatus 200a may apply at least one of the obtained user information, product information, or environment information to the trained model.

According to one embodiment, when the obtained information is not preprocessed, the product price assessing apparatus 200a may preprocess at least one of the obtained user information, product information, or environment information, and then input the preprocessed information into the trained model.

According to one embodiment, in order to assess an acquisition price of the subscription product, the product price assessing apparatus 200a may input at least one of the obtained user information, product information, or environment information, into the trained model that is trained to assess, based on a product information training data set according to a type of each product, product prices at which users determine to acquire the product.

According to one embodiment, the trained model may be a trained model that is trained based on the product information training data set for a plurality of different products identified as being of a similar type. For example, for products classified as being similar beauty products, such as a hair dryer and a LED mask, product information generated from the hair dryer or LED mask, or user information related to buyers of the hair dryer or the LED mask may be used together as training data.

According to one embodiment, as a result of performing correlation analysis between information of products, products having a correlation greater than or equal to a predetermined criterion may be determined as being in the same product family. The products belonging to the same product family may configure the trained model to assess the product price using the same price assessing model. That is, the trained model may be a trained model that is configured to classify several products into a plurality of product families and to assess a product price using each price assessing model for each product family.

According to another embodiment, the product price assessing apparatus 200a may assess a product price of each of a plurality of products by inputting product information generated from different products into the same trained model, without sorting the products.

According to one embodiment, in order to determine whether to suggest to a user whether to acquire a subscription product, the product price assessing apparatus 200a may input at least one of the obtained user information, product information, or environmental information into the trained model for assessing an acquisition price or a separate trained model. In such a case, the trained model for determining whether to suggest to the user whether to acquire the product may be a trained model that is trained to assess, based on at least one of the user information, the product information, or the environment information, a product price by using the product price at which any user determines to acquire the product or information related to a time of when to determine whether to acquire the product.

According to one embodiment, the product price assessing apparatus 200a may determine whether to suggest to the user whether to acquire the subscription product in a periodical or non-periodical manner based on the trained model, or may determine whether to suggest to the user whether to acquire the subscription product when any one of the user information, the product information, or the environment information changes to a determined criterion or greater. For example, when usage time of the user (product information) increases rapidly, the number of major purchasers having the same gender as the user (environment information) increases rapidly, or search frequency of the user for a similar product (user information) increases rapidly, the product price assessing apparatus 200a may determine whether to suggest to the user whether to acquire the subscription product.

In step S530, the product price assessing apparatus 200a may transmit, to the user terminal 100a, a price at which the user is most likely to acquire the product, among product acquisition prices assessed by the trained model, such that the user terminal 100a may display an interface for suggesting whether to acquire the subscription product at the received acquisition price.

In step S540, the product price assessing apparatus 200a may receive, from the user terminal 100a, whether the user determines to acquire the subscription product at the acquisition price which the product price assessing apparatus 200a transmits in step S530. In step S550, the product price assessing apparatus 200a may perform reinforcement learning by reflecting, as a reward, whether the user determines to acquire the product. Therefore, by the trained model that is reinforced according to whether users determine to acquire a product at the assessed acquisition price, the product price having a high acquisition possibility in the future acquisition may be assessed. When the trained model is changed by the reinforcement learning, the product price assessed by the changed trained model may be transmitted to the user terminal 100a at another time.

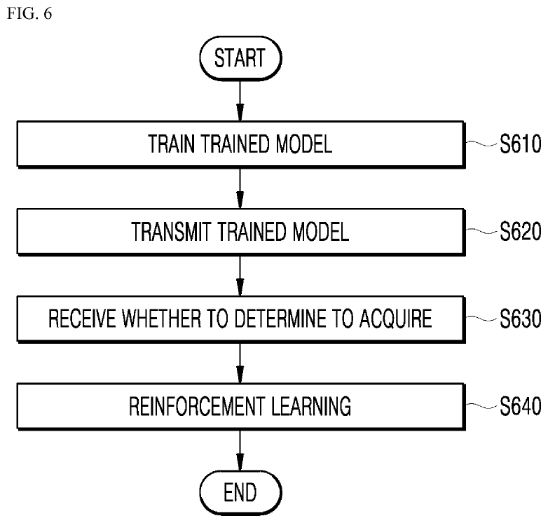

FIG. 6 is a flowchart illustrating operations of a trained model generating and distributing method for assessing a product price and reinforcement learning method in the trained model generating and distributing apparatus 200b corresponding to the machine learning-based electronic device shown in FIG. 4. In the following description, a description overlapping with those of FIGS. 1 to 5 will be omitted.

Referring to FIG. 6, in step S610, the generating and distributing apparatus 200b may train a trained model with a training data set having, as a label, a price at which a user acquired a product under a particular condition of at least one of user information, product information, or environment information.

According to one embodiment, the generating and distributing apparatus 200b may receive product list information which is set in a user terminal, and train the trained model for each user. In such a case, the trained model is a trained model that is trained with the training data set having, as a label, a price at which any user acquired a subscription product based on the condition that the product information of the same or similar type as the subscription product is included. For example, when a specific user subscribes to a hair dryer, the generating and distributing apparatus 200b may transmit, to a user terminal of the specific user, a trained model that is trained based on product information of the hair dryer according to a predetermined criterion, or a trained model that is trained based on the condition that product information of a hair dryer determined as being of a similar type to the hair dryer is included.

According to another embodiment, the generating and distributing apparatus 200b may receive the user information which is set in the user terminal, and transmit, to the user terminal, a trained model that is trained with a training data set having, as a label, a price at which a user acquired a product based on the condition that user information of users similar to the user information which is set in the user terminal is included. For example, when a specific user is a male residing in region a, the generating and distributing apparatus 200b may transmit, to a user terminal of the specific user, a machine learning-based trained model that is trained with a training data set having, as labels, prices that men residing in region A geographically covering the region a acquired a product. In such a case, the trained model may be a trained model that is trained based on similar or non-similar product information.

In step S620, the generating and distributing apparatus 200b may transmit the trained model, which has been trained, to the user terminal 100b, and the user terminal 100b may assess an acquisition price by applying, to the received trained model, any one of the user information, the environment information, and the product information received from the user-possessed product 300b or a separate home IoT server (not shown). The user terminal 100b may suggest the assessed acquisition price to the user via a user interface, and obtain information on whether the acquisition price is accepted by the user.

In step S630, the generating and distributing apparatus 200b may receive, from the user terminal 100b, information on whether the user accepts the acquisition and the acquisition price suggested to the user. In step S640, the generating and distributing apparatus 200b may perform reinforcement learning by reflecting, as a reward, the acquisition price to the trained model.

When the trained model is changed, the generating and distributing apparatus 200b may retransmit the changed trained model or related parameters (for example, a threshold value, a weighting value, a transfer function, and a neural network structure) to the user terminal 100b, and may then control the user terminal 100b such that the user terminal 100b assesses the product price based on the changed trained model. In step S630, the generating and distributing apparatus 200b may also receive, from the user terminal 100b, information related to an acquisition suggestion time of the subscription product suggested to the user, and may perform reinforcement learning by reflecting in the trained model, as a reward, the received information along with the information on whether the user accepts the acquisition and the acquisition price suggested to the user.

The present disclosure described above may be implemented as a computer-readable code in a medium on which a program is recorded. The computer-readable medium may include all types of recording devices in which computer-readable data is stored. Examples of the computer-readable medium include a Hard Disk Drive (HDD), a Solid State Disk (SSD), a Silicon Disk Drive (SDD), a ROM, a RAM, a CD-ROM, a magnetic tape, a floppy disk, an optical data storage device, etc. Moreover, the computer may include the processor 180 of a terminal.

1. A product price assessing method by a machine learning-based electronic device,
comprising:
applying preprocessed data of at least one of user information, product information, or environment information to a machine learning-based first trained model; and
assessing a product price of a product related to the product information based on the first trained model,
wherein the first trained model is a trained model that has been previously trained to assess, based on the at least one of the user information, the product information, or the environment information, a product price at which a user determines to acquire the product, and is reinforced by reflecting, as a reward, whether the user determines to acquire the product at the assessed product price.

2. The method according to claim 1,
wherein the product information is information related to usage history of the product or usage status of the product, and
wherein at least some of the product information is based on information sensed by a sensor provided in the product.

3. The method according to claim 2,
wherein the applying comprises applying preprocessed data of at least one of product information generated from a plurality of different types of products, user information related to the plurality of products, or environment information, to the first trained model, and
wherein the assessing comprises assessing a product price of each of the plurality of products.

4. The method according to claim 3,
wherein the first trained model is a trained model that checks a correlation between the plurality of different types of products based on the product information generated from the plurality of products inputted in a training step and then determines that the plurality of products having a correlation greater than or equal to a predetermined criterion belong to the same product family, and that is configured to assess product prices of the plurality of products belonging to the same product family by using a price assessing model preset for the corresponding product family.

5. The method according to claim 1,
wherein the user information comprises at least one of a type, a model name, a price, a function, a search frequency, or a reading frequency of a product of interest searched or read by the user, and
wherein at least some of the user information is based on information collected from a terminal of the user.

6. The method according to claim 1,
further comprising determining whether to suggest to the user whether to acquire the product, by applying at least one of the user information, the product information, or the environment information to a second trained model,
wherein the second trained model is a trained model that has been previously trained to estimate, based on at least one of the user information, the product information, or the environment information, a time of when the user is most likely to acquire the product, and
wherein the second trained model is reinforced by reflecting, as a reward, whether the user determines to acquire the product with respect to an acquisition suggestion made at the estimated time.

7. A trained model generating and distributing method for assessing a product price by a machine learning-based learning device, comprising:
training a machine learning-based trained model with preprocessed training data of at least one of user information, product information, or environment information;
transmitting the trained model, which has been trained with preprocessed training data, to a user terminal; and
reinforcing the trained model by receiving, from the user terminal, whether a user determines to acquire a product at the product price assessed based on the trained model, which has been trained with preprocessed training data, and by reflecting, as a reward, whether the user determines to acquire the product,
wherein the training data is a data set having, as a label, a price at which the user acquired the product under a particular condition of at least one of the user information, the product information, or the environment information.

8. The method according to claim 7,
further comprising receiving product list information which is set in the user terminal, and
wherein the training a trained model comprises training the machine learning-based trained model with product information related to a product of the set product list information and the training data having, as the label, the price at which the user acquired the corresponding product.

9. The method according to claim 7,
further comprising receiving the user information which is set in the user terminal, and
wherein the training a trained model comprises training the machine learning-based trained model with user information of a plurality of users determined to be similar according to the set user information and a predetermined criterion, and the training data having, as the label, prices at which the plurality of users acquired the product.

10. A computer-readable recording medium having a recorded program for executing the method of claim 1 by using a computer.

11. A machine learning-based product price assessing apparatus, comprising:
a memory configured to store at least one command and at least a portion of data related to a trained model; and
a processor configured to execute the stored at least one command,
wherein the processor is configured to:
apply preprocessed data of at least one of user information, product information, or environment information to the trained model that is based on machine learning, and
assess a product price of a product related to the product information based on the trained model,
wherein the trained model has been previously trained to assess, based on at least one of the user information, the product information, or the environment information, a product price at which a user determines to acquire the product, and is reinforced by reflecting, as a reward, whether the user determines to acquire the product at the assessed product price.

12. A machine learning-based trained model generating and distributing apparatus, comprising:
a memory configured to store at least one command; and
a processor configured to execute the stored at least one command,
wherein the processor is configured to:
train the machine learning-based trained model with preprocessed training data of at least one of user information, product information, or environment information,
transmit the trained model to a user terminal such that the user terminal assesses a product price, and
reinforce the trained model by receiving, from the user terminal, whether a user determines to acquire a product at the product price assessed based on the trained model, and by reflecting, as a reward, whether the user determines to acquire the product,
wherein the training data is a data set having, as a label, a price at which the user acquired the product under a particular condition of at least one of the user information, the product information, or the environment information.

13. A user terminal using a machine learning-based trained model, comprising:
a memory configured to store at least one command and parameters of the machine learning-based trained model;
a communicator configured to receive the trained model from a learning device and to receive product information from at least one external electronic device; and
a processor configured to apply preprocessed data of at least one of user information, the product information, or environment information to the trained model, and to control the user terminal such that the user terminal displays, to a user, an interface related to a determining of an acquisition of a product related to the product information according to a result of assessing a product price of the product based on the trained model,
wherein the communicator is configured to transmit, to the learning device, information related to whether the user determines to acquire the product, such that the learning device reinforces the trained model by reflecting, as a reward, whether the user determines to acquire the product at the assessed product price.

14. A computer-readable recording medium having a recorded program for executing the method of claim 7 by using a computer.
